(19) United States
(12) Patent Application Publication
(10) Pub. No.: US 2022/0262211 A1
(43) Pub. Date: Aug. 18, 2022

(54) Vehicle Gratitude Communication System

(71) Applicant: Lettie Ordone, Manteca, CA (US)

(72) Inventor: Lettie Ordone, Manteca, CA (US)

(21) Appl. No.: 17/177,273

(22) Filed: Feb. 17, 2021

(51) Int. Cl. G08B 5/00; H04B 7/26; B60R 11/02

(52) U.S. Cl. CPC G08B 5/00; B60R 11/0235; H04B 7/26

(57) ABSTRACT

A vehicle gratitude communication system for communicating gratitude to other drivers includes a display apparatus and a remote apparatus. The display apparatus comprises a housing. A display is coupled within a housing front side and includes a translucent lettering portion and a backlight to selectively illuminate the lettering portion. A display battery and a receiver are coupled within the housing. A plurality of display engagement members is coupled to the housing front side and is configured to selectively engage a rear windshield of a vehicle. The remote apparatus comprises a transmitter coupled within a remote casing in wireless communication with the receiver. A power button is coupled to the remote casing and is in operational communication with the transmitter to illuminate the backlight of the display apparatus. A remote battery is coupled within the remote casing and is in operational communication with the transmitter.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to vehicle communication devices and more particularly pertains to a new vehicle communication device for communicating gratitude to other drivers. The device includes a flexible frame and a flexible display body to allow the device to conform to the curvature of a vehicle rear windshield. The device also includes fixed translucent lettering to be illuminated.

### (2) Description of Related Art including information disclosed under 37 CFR 1.97 and 1.98.

The prior art relates to vehicle communication devices. Existing devices are rigid and lack the flexibility required to conform to the curvature of a rear windshield. Known devices also include customizable displays and thus require more components and a more complex system of programming the message to be displayed. These devices also lack a status indicator on a wireless remote control.

### (h) BRIEF SUMMARY OF THE INVENTION

An embodiment of the disclosure meets the needs presented above by generally comprising a display apparatus and a remote apparatus. The display apparatus comprises a housing having a housing front side, a housing back side, a housing left side, a housing right side, a housing top side, and a housing bottom side. A display is coupled to the housing. The display is coupled within the housing front side and includes a translucent lettering portion and a backlight to selectively illuminate the lettering portion. A display battery is coupled within the housing and is in operational communication with the backlight. A receiver is coupled within the housing and is in operational communication with the backlight. A plurality of display engagement members is coupled to the housing. Each display engagement member is coupled to the housing front side and is configured to selectively engage a rear windshield of a vehicle. The remote apparatus comprises a remote casing having a casing front side, a casing back side, and a casing perimeter. A transmitter is coupled within the remote casing and is in wireless communication with the receiver of the display apparatus. A power button is coupled to the remote casing. The power button is in operational communication with the transmitter to illuminate the backlight of the display apparatus. A remote battery is coupled within the remote casing and is in operational communication with the transmitter. A remote engagement member is coupled to the remote casing. The remote engagement member is coupled to the casing back side and is configured to selectively engage a dashboard of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a vehicle gratitude communication system according to an embodiment of the disclosure.

FIG. 2 is a rear elevation view of an embodiment of the disclosure.

FIG. 3 is a front elevation view of an embodiment of the disclosure.

FIG. 4 is an in-use view of an embodiment of the disclosure.

FIG. 5 is a top plan view of an embodiment of the disclosure.

FIG. 6 is a bottom plan view of an embodiment of the disclosure.

### (j) DETAILED DESCRIPTION OF THE INVENTION

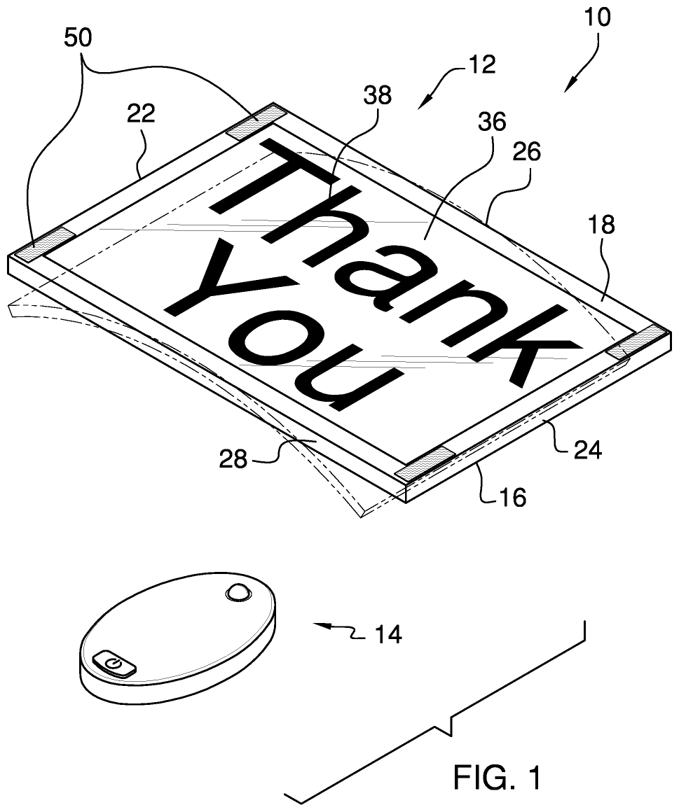

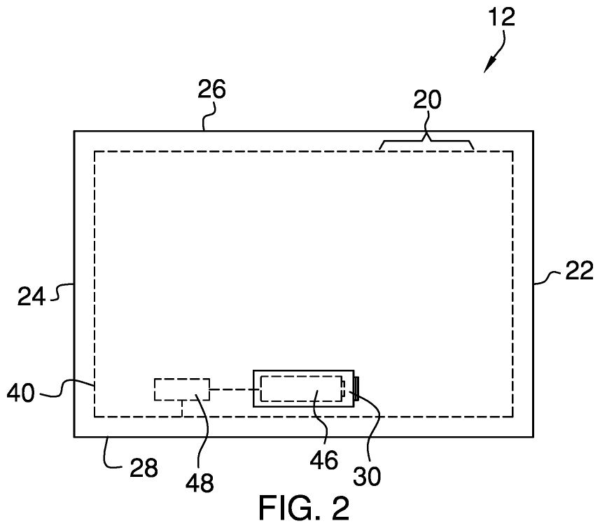

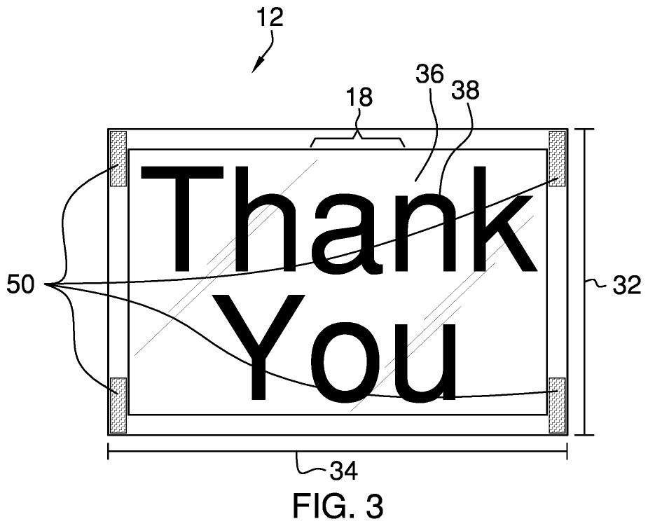

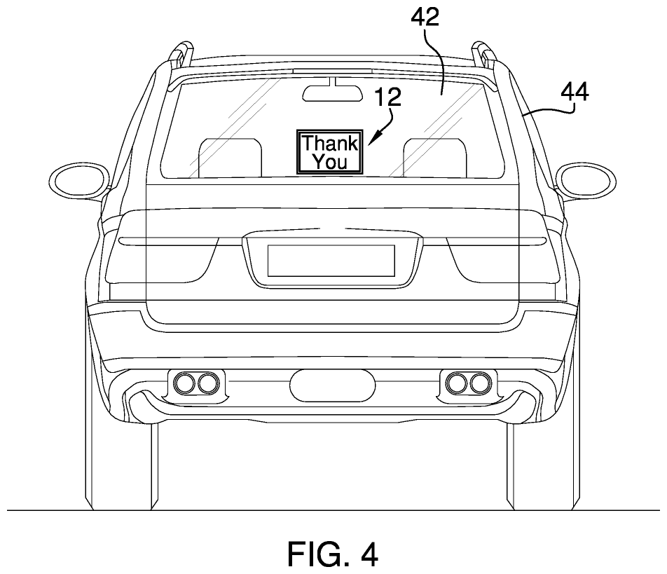

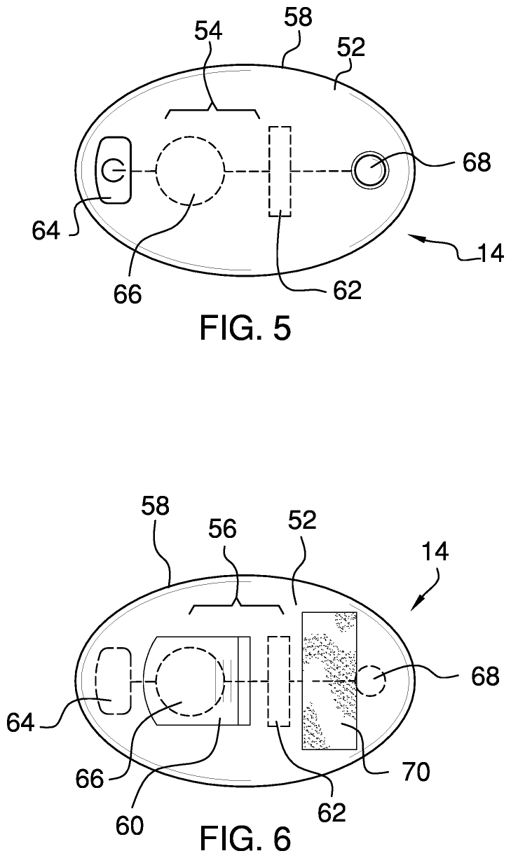

With reference now to the drawings, and in particular to FIGS. 1 through 6 thereof, a new vehicle communication device embodying the principles and concepts of an embodiment of the disclosure and generally designated by the reference numeral 10 will be described.

As best illustrated in FIGS. 1 through 6, the vehicle gratitude communication system 10 generally comprises a display apparatus 12 and a remote apparatus 14. The display apparatus 12 comprises a housing 16 having a housing front side 18, a housing back side 20, a housing left side 22, a housing right side 24, a housing top side 26, and a housing bottom side 28. The housing back side 20 may have a selectively removable housing battery cover 30. A height 32 of the housing may be equal to two-thirds of a width 34 of the housing.

A display 36 is coupled to the housing 16. The display 36 is coupled within the housing front side 18. The display 36 includes a translucent lettering portion 38 and a backlight 40 to selectively illuminate the lettering portion 38. The lettering portion 38 may form a message of gratitude such as, but not limited to, “THANK YOU”, “THANKS”, and “THX”. The lettering portion 38 is only visible when the backlight 40 is activated. The housing 16 and the display 36 may be rectangular and may be sufficiently flexible so as to conform to the curvature of a rear windshield 42 of a vehicle 44. A display battery 46 is coupled within the housing 16. The display battery 46 is in operational communication with the backlight 40. A receiver 48 is coupled within the housing 16 and is in operational communication with the backlight 40.

A plurality of display engagement members 50 is coupled to the housing 16. Each display engagement member 50 is coupled to the housing front side 18 and configured to selectively engage the rear windshield 42 of the vehicle. The plurality of display engagement members 50 may be four display engagement members 50 coupled within the corners of the housing front side 18.

The remote apparatus 16 comprises a remote casing 52 having a casing front side 54, a casing back side 56, and a casing perimeter 58. The remote casing 52 may be oval-shaped. The casing back side 56 may have a selectively removable casing battery cover 60.

A transmitter 62 is coupled within the remote casing 52 and is in wireless communication with the receiver 48 of the display apparatus. A power button 64 is coupled to the remote casing 52. The power button 64 may be coupled to the casing front side 54 and is in operational communication with the transmitter 62 to illuminate the backlight 40 of the display apparatus. A remote battery 66 is coupled within the remote casing 52 and is in operational communication with the transmitter 62. A status light 68 may be coupled to the remote casing 52. The status light 68 is coupled to the casing front side 54 and is in operational communication with the transmitter 62 and the remote battery 66 to illuminate when the backlight 40 of the display apparatus is illuminated.

A remote engagement member 70 is coupled to the remote casing 52. The remote engagement member 70 is coupled to the casing back side 56 and configured to selectively engage a dashboard of the vehicle 44. Each display engagement member 50 and the remote engagement member 70 may be, but are not limited to, a selectively engageable fastener such as hook-and-loop, adhesives, and the like.

In use, the power button 64 is activated as desired to illuminate the backlight 40 and make the lettering portion 38 visible to other drivers. The power button 64 may be pressed again to turn off the backlight 40. The user may check the status light 68 to avoid accidentally leaving the backlight 40 on.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A vehicle gratitude communication system comprising:
a display apparatus comprising:
a housing having a housing front side, a housing back side, a housing left side, a housing right side, a housing top side, and a housing bottom side;
a display coupled to the housing, the display being coupled within the housing front side, the display including a translucent lettering portion and a backlight to selectively illuminate the lettering portion;
a display battery coupled within the housing, the display battery being in operational communication with the backlight;
a receiver coupled within the housing, the receiver being in operational communication with the backlight; and
a plurality of display engagement members coupled to the housing, each display engagement member being coupled to the housing front side and configured to selectively engage a rear windshield of a vehicle; and
a remote apparatus comprising:
a remote casing having a casing front side, a casing back side, and a casing perimeter;
a transmitter coupled within the remote casing, the transmitter being in wireless communication with the receiver of the display apparatus;
a power button coupled to the remote casing, the power button being in operational communication with the transmitter to illuminate the backlight of the display apparatus;
a remote battery coupled within the remote casing, the remote battery being in operational communication with the transmitter; and
a remote engagement member coupled to the remote casing, the remote engagement member being coupled to the casing back side and configured to selectively engage a dashboard of the vehicle.

2. The vehicle gratitude communication system of claim 1 further comprising the lettering portion forming a message of gratitude such as, but not limited to, “THANK YOU”, “THANKS”, and “THX”.

3. The vehicle gratitude communication system of claim 1 further comprising a status light coupled to the remote casing, the status light being coupled to the casing front side and being in operational communication with the transmitter and the remote battery to illuminate when the backlight of the display apparatus is illuminated.

4. The vehicle gratitude communication system of claim 1 further comprising the remote casing being oval-shaped.

5. The vehicle gratitude communication system of claim 1 further comprising the power button being coupled to the casing front side.

6. The vehicle gratitude communication system of claim 1 further comprising the housing back side having a selectively removable housing battery cover; the casing back side having a selectively removable casing battery cover.

7. The vehicle gratitude communication system of claim 1 further comprising the housing and the display being rectangular.

8. The vehicle gratitude communication system of claim 7 further comprising the plurality of display engagement members being four display engagement members coupled within the corners of the housing front side.

9. The vehicle gratitude communication system of claim 1 further comprising the housing and the display being sufficiently flexible so as to conform to the curvature of the rear windshield of the vehicle.

10. A vehicle gratitude communication system comprising:
a display apparatus comprising:
a housing having a housing front side, a housing back side, a housing left side, a housing right side, a housing top side, and a housing bottom side, the housing back side having a selectively removable housing battery cover;
a display coupled to the housing, the display being coupled within the housing front side, the display including a translucent lettering portion and a backlight to selectively illuminate the lettering portion, the lettering portion forming a message of gratitude such as, but not limited to, “THANK YOU”, “THANKS”, and “THX”, the housing and the display being rectangular, the housing and the display being sufficiently flexible so as to conform to the curvature of a rear windshield of a vehicle;
a display battery coupled within the housing, the display battery being in operational communication with the backlight;
a receiver coupled within the housing, the receiver being in operational communication with the backlight; and
a plurality of display engagement members coupled to the housing, each display engagement member being coupled to the housing front side and configured to selectively engage the rear windshield of the vehicle, the plurality of display engagement members being four display engagement members coupled within the corners of the housing front side; and
a remote apparatus comprising:
a remote casing having a casing front side, a casing back side, and a casing perimeter, the remote casing being oval-shaped, the casing back side having a selectively removable casing battery cover;
a transmitter coupled within the remote casing, the transmitter being in wireless communication with the receiver of the display apparatus;
a power button coupled to the remote casing, the power button being coupled to the casing front side and being in operational communication with the transmitter to illuminate the backlight of the display apparatus;
a remote battery coupled within the remote casing, the remote battery being in operational communication with the transmitter;
a status light coupled to the remote casing, the status light being coupled to the casing front side and being in operational communication with the transmitter and the remote battery to illuminate when the backlight of the display apparatus is illuminated; and
a remote engagement member coupled to the remote casing, the remote engagement member being coupled to the casing back side and configured to selectively engage a dashboard of the vehicle.
